(19) United States
(12) Patent Application Publication
(10) Pub. No.: US 2025/0390111 A1
(43) Pub. Date: Dec. 25, 2025

(54) Systems, Apparatuses, and Methods For Charging Power Supplies of Robotic Devices

(71) Applicant: Brain Corporation, San Diego, CA (US)

(72) Inventors: Jeremiah Cox, San Diego, CA (US); Nagarakshith Makam Sreenivasulu, San Diego, CA (US)

(21) Appl. No.: 19/241,996

(22) Filed: Jun. 18, 2025

Related U.S. Application Data
(60) Provisional application No. 63/662,469, filed on Jun. 21, 2024.

(51) Int. Cl. G05D 1/661; B60L 53/16; B60L 53/36; G05D 1/244

(52) U.S. Cl. CPC G05D 1/661; B60L 53/16; B60L 53/36; G05D 1/2446

(57) ABSTRACT

Systems and methods for charging power supplies of robotic devise are disclosed herein. A charging dock includes a first surface comprising at least one axis of symmetry defining aligned with a normal approach angle of the robot, two or more charging pads configured to transfer charge and are disposed on a first outer surface of the charging dock, at least one or more slanted surfaces, wherein each of the one or more slanted surfaces are slanted with respect to the first outer surface, and at least one or more computer readable codes affixed to at least one of the one or more slanted surfaces and a flat surface of the charging dock in a position of the charging dock that is transverse to the normal approach angle.

### CROSS-REFERENCE TO RELATED APPLICATIONS

This application claims the benefit of and priority to U.S. Provisional Patent Application No. 63/662,469, filed Jun. 21, 2024, entitled “Systems, Apparatuses, And Methods For Charging Power Supplies of Robotic Devices,” under 35 U.S.C. § 119 and/or 35 U.S.C. § 120, the entire disclosure of which is hereby incorporated by reference herein for all purposes.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for charging power supplies of robotic devices.

### SUMMARY

The foregoing needs are satisfied by the present disclosure, which provides for, inter alia, systems and methods for charging power supplies of robotic devices.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a charging dock for providing power to a robot is disclosed. The charging dock, comprises a first surface comprising at least one axis of symmetry which defines or is aligned with an approach angle normal to a surface of a charging port; the charging port comprising two or more charging pads disposed on a first outer surface of the charging dock; one or more slanted surfaces, wherein each of the one or more slanted surfaces are slanted with respect to the first outer surface; and one or more computer readable codes affixed to the charging dock in a position transverse to the normal approach angle.

According to at least one non-limiting exemplary embodiment, at least one of the one or more computer readable codes is affixed to at least one of the one or more slanted surfaces.

According to at least one non-limiting exemplary embodiment, each of the one or more computer readable codes comprises instructions stored thereon that, when detected by a sensor of the robot, cause the robot to determine a known location of the charging dock based at least in part on a known association between the detected computer readable code and the known location; and determine a position of the robot relative to the detected computer readable code.

According to at least one non-limiting exemplary embodiment, the charging port comprises at least one magnet disposed from the two or more charging pads at a distance equal to a spatial separation between another opposing pair of magnets of a collector module and corresponding charging pads thereof, the collector module corresponding to a component of the robot configured to receive charge from the charging pads.

According to at least one non-limiting exemplary embodiment, the charging dock further comprises a top section comprising one or more light emitting elements configured to indicate power transmission; a middle section comprising the one or more slated surfaces which intersect with a second surface at the base of the middle section, the second surface is parallel to the floor and comprises a shape with one axis of symmetry; and a lower section comprising the first surface, the first surface being a flat surface which extends from the floor upward to the second surface, and includes one or more batteries, power management circuitry, and adapters for external power sources; wherein, the one or more computer readable codes are affixed to at least one of the top section or middle section.

According to at least one non-limiting exemplary embodiment, a collector module for a robot for receiving charge from a charging dock is disclosed. The collector module, comprises an outer casing; an inner casing disposed within the outer casing; a hall effect sensor disposed within the inner casing; one or more springs coupled to a surface of the inner casing internal to the collector module; a pair of charging pads on an external face of the inner casing; at least one magnet disposed within the inner casing and positioned adjacent to the charging pads; and a circuit configured to couple a power supply of the robot to the charging dock via a pair of corresponding charging pads of the charging dock.

In some aspects, the techniques described herein relate to a charging system for a robot, including: a charging dock system including: a first surface including an axis of symmetry which is aligned with an approach angle normal to a charging port, the charging port including two or more charging pads; one or more slanted surfaces; and one or more positioning codes affixed to the charging dock in a position transverse to the approach angle; a robot navigation system configured to: detect the one or more positioning codes; determine a location of the charging dock based on the detected positioning codes; and determine a position of the robot relative to the detected positioning codes to align the robot with the charging dock; and a collector module system including: a pair of charging pads disposed on an external face of an inner casing at a distance equal to a spatial separation between the two or more charging pads of the charging dock; one or more magnets disposed within the inner casing adjacent to the pair of charging pads; one or more springs coupled to a surface of the inner casing; and a circuit configured to couple a power supply of the robot to the charging dock via the pair of charging pads of the collector module system and the two or more charging pads of the charging dock.

In some aspects, the techniques described herein relate to a charging system, wherein the one or more positioning codes include instructions that, when detected by a sensor of the robot, cause the robot navigation system to determine the location of the charging dock and the position of the robot.

In some aspects, the techniques described herein relate to a charging system, wherein the collector module system further includes: an outer casing; and the inner casing disposed within the outer casing.

In some aspects, the techniques described herein relate to a charging system, wherein the collector module system further includes: a hall effect sensor disposed within the inner casing, the hall effect sensor configured to detect alignment between the collector module system and the charging dock system.

In some aspects, the techniques described herein relate to a charging system, wherein the first surface of the charging dock system includes at least one axis of symmetry.

In some aspects, the techniques described herein relate to a charging system, wherein the two or more charging pads of the charging dock system are disposed on a first outer surface of the charging dock.

In some aspects, the techniques described herein relate to a charging system, wherein the one or more slanted surfaces are slanted with respect to the first outer surface.

In some aspects, the techniques described herein relate to a method for charging a robot, including: providing a charging dock system including a first surface, the first surface including an axis of symmetry which is aligned with an approach angle normal to a charging port, the charging port including two or more charging pads, one or more slanted surfaces, and one or more positioning codes affixed to the charging dock in a position transverse to the approach angle; detecting, by a robot navigation system, the one or more positioning codes; determining, by the robot navigation system, a location of the charging dock based on the detected positioning codes; determining, by the robot navigation system, a position of the robot relative to the detected positioning codes to align the robot with the charging dock; aligning a collector module system of the robot with the charging dock system, the collector module system including a pair of charging pads disposed on an external face of an inner casing at a distance equal to a spatial separation between the two or more charging pads of the charging dock, one or more magnets disposed within the inner casing adjacent to the pair of charging pads, and one or more springs coupled to a surface of the inner casing; and coupling, via a circuit, a power supply of the robot to the charging dock via the pair of charging pads of the collector module system and the two or more charging pads of the charging dock.

In some aspects, the techniques described herein relate to a method, wherein the one or more positioning codes include instructions that, when detected by a sensor of the robot, cause the robot navigation system to determine the location of the charging dock and the position of the robot.

In some aspects, the techniques described herein relate to a method, wherein aligning the collector module system of the robot with the charging dock system further includes: detecting, by a hall effect sensor disposed within the inner casing of the collector module system, alignment between the collector module system and the charging dock system.

In some aspects, the techniques described herein relate to a method, wherein the first surface of the charging dock system includes at least one axis of symmetry.

In some aspects, the techniques described herein relate to a method, wherein the two or more charging pads of the charging dock system are disposed on a first outer surface of the charging dock.

In some aspects, the techniques described herein relate to a method, wherein the one or more slanted surfaces are slanted with respect to the first outer surface.

In some aspects, the techniques described herein relate to a robot, including: a navigation system configured to: detect one or more positioning codes affixed to a charging dock; determine a location of the charging dock based on the detected positioning codes; and determine a position of the robot relative to the detected positioning codes to align the robot with the charging dock; and a collector module system including: a pair of charging pads disposed on an external face of an inner casing at a distance equal to a spatial separation between two or more charging pads of the charging dock; one or more magnets disposed within the inner casing adjacent to the pair of charging pads; one or more springs coupled to a surface of the inner casing; and a circuit configured to couple a power supply of the robot to the charging dock via the pair of charging pads of the collector module system and the two or more charging pads of the charging dock.

In some aspects, the techniques described herein relate to a robot, wherein the one or more positioning codes include instructions that, when detected by a sensor of the robot, cause the navigation system to determine the location of the charging dock and the position of the robot.

In some aspects, the techniques described herein relate to a robot, wherein the collector module system further includes: an outer casing; and the inner casing disposed within the outer casing.

In some aspects, the techniques described herein relate to a robot, wherein the collector module system further includes: a hall effect sensor disposed within the inner casing, the hall effect sensor configured to detect alignment between the collector module system and the charging dock.

In some aspects, the techniques described herein relate to a robot, wherein the charging dock includes a first surface aligned with an approach angle normal to a charging port, the charging port including the two or more charging pads.

In some aspects, the techniques described herein relate to a robot, wherein the charging dock further includes one or more slanted surfaces to guide the robot, the one or more slanted surfaces being slanted with respect to a first outer surface of the charging dock on which the two or more charging pads are disposed.

In some aspects, the techniques described herein relate to a robot, wherein the first surface of the charging dock includes at least one axis of symmetry which is aligned with a surface normal of the pair of charging pads.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2 is a system diagram of a server coupled to a plurality of robotic devices in accordance with some embodiments of this disclosure.

FIGS. 3A(i-ii) depict a frontward and side view, respectively, of a collector module of a robot configured to receive charge, according to exemplary embodiments of this disclosure.

FIGS. 3B(i-ii) illustrate an extension of an inner casing of a collector module which causes it to couple with a charging dock with angular tolerance, according to exemplary embodiments of this disclosure.

FIGS. 4(i-ii) depict a frontward and side angle view, respectively, of a charging dock and features thereof, according to exemplary embodiments of this disclosure.

FIG. 5(i) depicts various sensor arrangements compatible with a charging dock, according to exemplary embodiments of this disclosure.

FIG. 5(ii) depicts another charging dock with compatible sensor arrangements, according to exemplary embodiments of this disclosure.

FIG. 6 depicts an exemplary embodiment of a charging dock in accordance with the inventive aspects of this disclosure.

FIG. 7 is a circuit schematic illustrating coupling a collector module to a power supply of a robot, according to exemplary embodiments of this disclosure.

FIG. 8 is a process flow or state diagram of a charging dock, in accordance with exemplary embodiments of this disclosure.

FIG. 9 is a process flow diagram outlining a method for a controller of a robot to couple to a charging dock to receive power, according to exemplary embodiments of this disclosure.

All Figures disclosed herein are @ Copyright 2025 Brain Corporation. All rights reserved.

### DETAILED DESCRIPTION

Currently, autonomous robots typically include integrated power supplies which are internal to their systems. These power supplies have finite capacity which, eventually, needs to be replenished. Depending on the task for the robot, the ability to navigate precisely to a charging dock may vary. For instance, home robots which navigate a route of a few hundred feet or less may be less susceptible to drift/delocalization, thereby enabling them to accurately position themselves with respect to a charging port. Further, use of feature-based localization (i.e., sensing a known, static object to determine location) may be useful in a home or complex environment setting, but may fail in large and empty spaces, such as warehouses, or spaces with indistinguishable features, such as individual aisles in a supermarket. Further, in these large spaces localization errors and drift may accumulate to a substantial degree, wherein a robot may not be able to accurately localize itself to a required level of accuracy needed to couple charging pads to a dock (without making excessively large charging pads to account for error). Accordingly, there is a need in the art for robots operating in large, feature-poor spaces (i.e., spaces with few or no features) to be able to accurately position themselves at the end of their routes/tasks to couple to a charging dock in order to recharge.

Additionally, robot sensors can drift over time and thereby require calibration. Accordingly, the charging dock in the following disclosure will confer added benefits beyond merely providing power by further enabling a robot to, while docked, calibrate its sensors.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for charging power supplies of robotic devices. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X. USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enable robots to accurately couple to a charging dock despite drift and other localization imperfections; (ii) provide calibration systems to robots without additional objects, targets, or human effort; and (iii) preserve safety in charging/discharging of robot power supplies. Other advantages are readily discernable by one having ordinary skill in the art given the contents of the present disclosure.

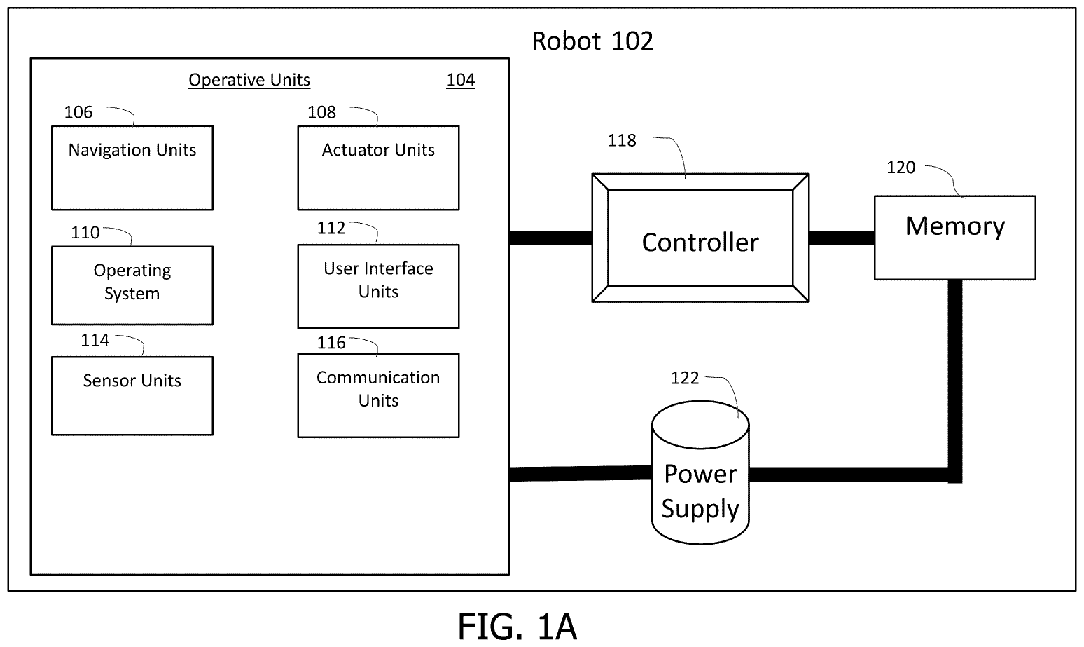

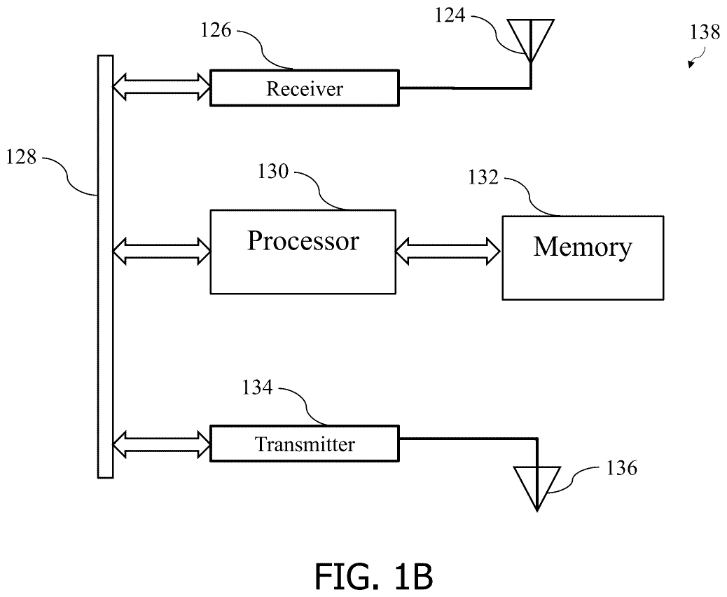

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), Fire Wire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

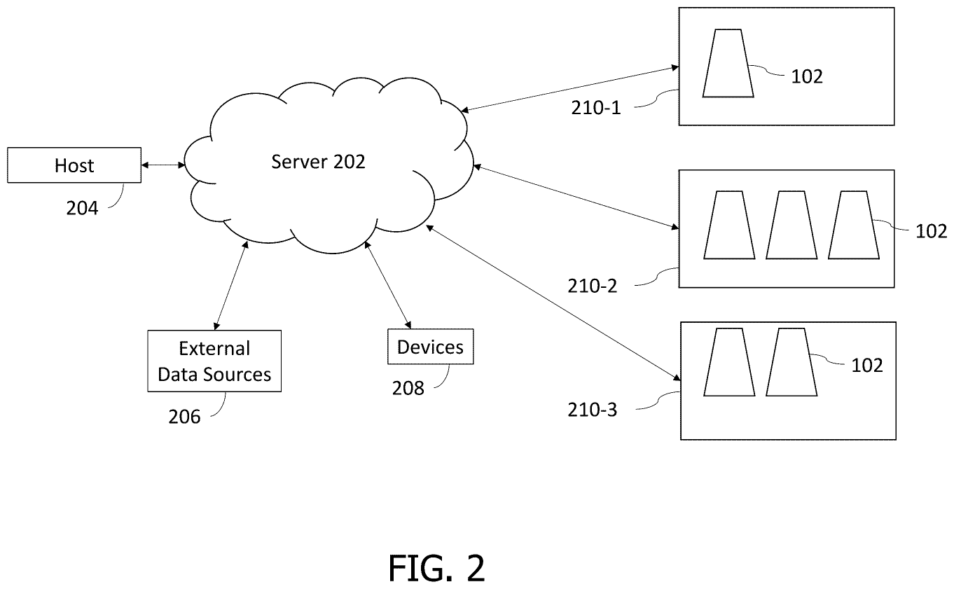

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

FIG. 2 illustrates a server 202 and communicatively coupled components thereof in accordance with some exemplary embodiments of this disclosure. The server 202 may comprise one or more processing units depicted in FIG. 1B, each processing unit comprising at least one processor 130 and memory 132 therein in addition to, without limitation, any other components illustrated in FIG. 1B. The processing units may be centralized at a location or distributed among a plurality of devices (e.g., a cloud server or dedicated server). Communication links between the server 202 and coupled devices may comprise wireless and/or wired communications, wherein the server 202 may further comprise one or more coupled antenna to effectuate the wireless communication. The server 202 may be coupled to a host 204, wherein the host 204 may correspond to a high-level entity (e.g., an administrator) of the server 202. The host 204 may, for example, upload software and/or firmware updates for the server 202 and/or coupled devices 208 and 210, connect or disconnect devices 208 and 210 to the server 202, or otherwise control operations of the server 202. External data sources 206 may comprise any publicly available data sources (e.g., public databases such as weather data from the National Oceanic and Atmospheric Administration (NOAA), satellite topology data, public records, etc.) and/or any other databases (e.g., private databases with paid or restricted access) of which the server 202 may access data therein. Devices 208, which may be edge devices in a network, may comprise any device configured to perform a task at an edge of the server 202. These devices may include, without limitation, internet of things (IoT) devices (e.g., stationary CCTV cameras, smart locks, smart thermostats, etc.), external processors (e.g., external CPUs or GPUs), and/or external memories configured to receive and execute a sequence of computer readable instructions, which may be provided at least in part by the server 202, and/or store large amounts of data. That is, these devices 208 may send, receive, collect, and process data which is transmitted and utilized by the server 202.

Lastly, the server 202 may be coupled to a plurality of robot networks 210, each robot network 210 comprising a local network of at least one robot 102. Each separate network 210 may comprise one or more robots 102 operating within separate environments from each other. An environment may comprise, for example, a section of a building (e.g., a floor, room, or other space) or any space in which the robots 102 operate. Each robot network 210 may comprise a different number of robots 102 and/or may comprise different types of robots 102. For example, network 210-2 may comprise a scrubber robot 102, a vacuum robot 102, and a gripper arm robot 102, whereas network 210-1 may only comprise a robotic wheelchair 102, wherein network 210-2 may operate within a retail store while network 210-1 may operate in a home of an owner of the robotic wheelchair 102 or a hospital. Each robot network 210 may communicate data including, but not limited to, sensor data (e.g., RGB images captured, LiDAR scan points, network signal strength data from sensors 202, etc.), inertial measurement unit (IMU) data, navigation and route data (e.g., which routes were navigated), localization data of objects within each respective environment, and metadata associated with the sensor, IMU, navigation, and localization data. Each robot 102 within each network 210 may receive communication from the server 202 including, but not limited to, a command to navigate to a specified area, a command to perform a specified task, a request to collect a specified set of data, a sequence of computer readable instructions to be executed on respective controllers 118 of the robots 102, software updates, and/or firmware updates. One skilled in the art may appreciate that a server 202 may be further coupled to additional relays and/or routers to effectuate communication between the host 204, external data sources 206, devices 208, and robot networks 210 which have been omitted for clarity. It is further appreciated that a server 202 may not exist as a single hardware entity, rather may be illustrative of a distributed network of non-transitory memories and processors.

According to at least one non-limiting exemplary embodiment, each robot network 210 may comprise additional processing units as depicted in FIG. 1B and act as a relay between individual robots 102 within each robot network 210 and server 202. For example, each robot network 210 may represent a plurality of robots 102 coupled to a single Wi-Fi signal, wherein the robot network 210 may comprise in part a router or relay configurable to communicate data to and from the individual robots 102 and server 202. That is, each individual robot 102 is not limited to being directly coupled to server 202 and devices 206, 208.

One skilled in the art will appreciate that any determination or calculation described herein may comprise one or more processors of the server 202, edge devices 208, and/or robots 102 of networks 210 performing the determination or calculation by executing computer readable instructions. The instructions may be executed by a processor of the server 202 and/or may be communicated to robot networks 210 and/or edge devices 208 for execution on their respective controllers/processors in part or in their entirety (e.g., a robot 102 may calculate a coverage map using measurements 308 collected by itself or another robot 102). Advantageously, use of a centralized server 202 may enhance a speed at which parameters may be measured, analyzed, and/or calculated by executing the calculations (i.e., computer readable instructions) on a distributed network of processors on robots 102 and devices 208. Use of a distributed network of controllers 118 of robots 102 may further enhance functionality of the robots 102 as the robots 102 may execute instructions on their respective controllers 118 during times when the robots 102 are not in use by operators of the robots 102.

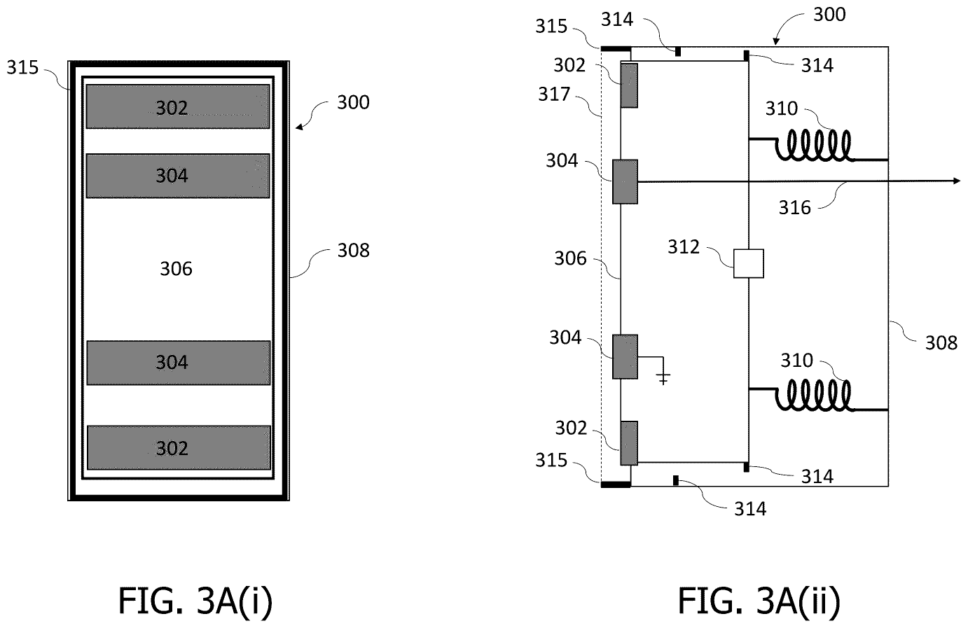

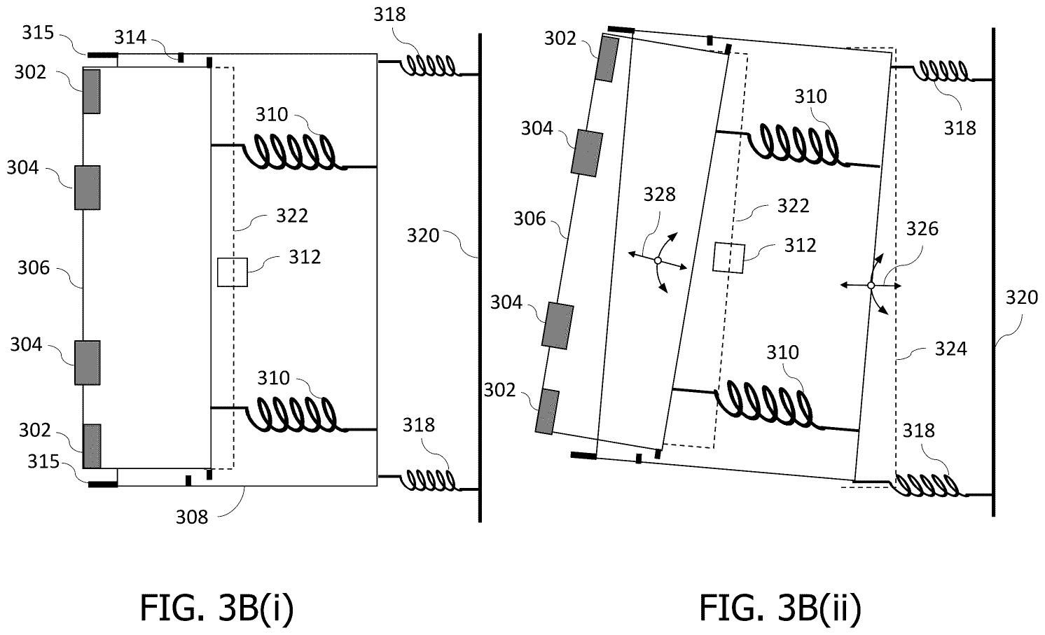

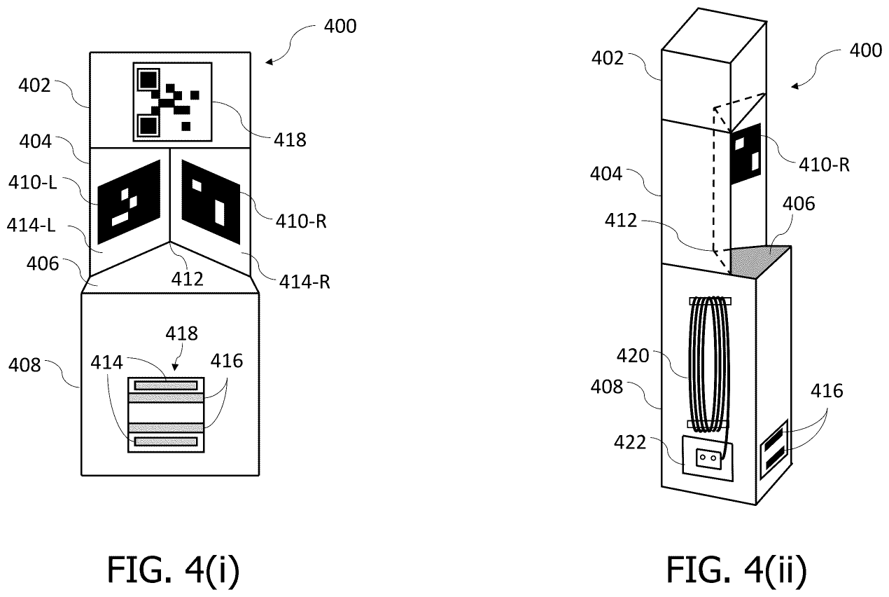

FIGS. 3A(i-ii) illustrate two views of a collector module 300 for use by a robot 102 to couple to a charging dock (e.g., charging dock 400 shown in FIGS. 4(i-ii)), according to an exemplary embodiment. FIG. 3A(i) shows a front-forward view of a collector module 300. The collector module 300 is comprised of an outer casing 308 and an inner casing 306, one or more magnets 302, and two or more charging pads 304(a) and 304(b) (which may collectively be referred to as charging pads 304). A charging pad, as used herein, refers to an exposed conductive element configured to couple, via physical contact, to another charging pad of another device to facilitate power transfer between the devices. Charging pads may comprise pairs of conductive elements to facilitate a ground and voltage channel and may be of any suitable shape (e.g., quadrilateral, elliptical, triangular, etc.). The inner casing 306 may be housed within the outer casing 308 with a loose fit tolerance which enables translational and rotational movement of inner casing 306 within outer casing 308, as discussed below in FIGS. 3B(i)-(ii). This allows the inner casing 306 to extend outward from the outer casing 308 and connect to stationary charging pads of a charging dock (shown as pads 416 in at least FIG. 4(i) below). The inner casing 306 is approximately a rectangular prism with only one exposed face (i.e., as shown by the front-forward view shown in FIG. 3A(i)) with the remaining faces being obscured within the outer casing 308. The collector module 300 may be disposed either within the robot 102 chassis or a charging dock body (e.g., charging dock 400 (see FIGS. 4(i)-(ii), 5(i)-(ii), 6)) wherein the device that does not include the collector module 300 (i.e., charging dock or robot chassis) would include stationary charging pads that may couple to the inner casing 306 when the collector module 300 is close and causes movement of the inner casing 306 via the magnets 302. In other words, the collector module 300 may be part of the robot 102, the charging dock 400, or both.

Magnets 302 may be fixed to the inner casing 306 such that when a magnetic source is in sufficient proximity to attract magnets 302, inner casing 306 may move translationally in the direction of the magnetic attraction and thereby extend out from the interior of outer casing 308 to affix to the magnetic source. In some embodiments, magnets 302 are configured to couple to opposingly polarized magnets disposed on a charging dock power supply (e.g., magnets 414 illustrated in FIGS. 4(i)-(ii). The magnets 302 coupling to the other magnets 414 of the charging dock cause the inner casing 306 to extend from the interior of outer casing 308, thereby creating contact between the charging pads 304 of the collector 300 to the charging pads of the charging dock. By enabling the inner casing 306 to be extendable to couple to the charging pads of the charging dock, the inner casing 306 and its magnets 302 and charging pads 304 can be recessed into the body of the robot when not in use.

The magnets 302 and charging pads 304 are enclosed within a protective border 315 which encloses the components. The protective border 315 is comprised of rubber of soft and durable material which can withstand repeated soft collisions. This enclosure shields shield the components from damage caused by, e.g., collisions, scratches, corrosion (e.g., from rain), and other environmental hazards as the robot 102 travels a route and can be more clearly seen in FIG. 3A(ii).

FIG. 3A(ii) shows a transparent side view of the collector module 300. The charging pads 304 as shown extend slightly (e.g., 1-3 millimeters) beyond a boundary of inner casing 306 and outward from the side of the inner casing 306 upon which the charging pads 304 lie (i.e., the leftmost side in FIG. 3A(ii), or the front-forward side shown in FIG. 3A(i)). One of the charging pads 304a is coupled to a power supply via trace 316 and a second charging pad 304b serves as ground as shown. One or more springs 310 couple the inner casing 306 to the outer casing 308 and enable the extension and retraction of the inner casing 306 into and out of the interior of the outer shell 308. A hall effect sensor 312 is disposed within the collector module 300 and generates a current when the magnetic field in which it resides changes, which occurs when the magnets 302 move (e.g., in response to an attractive magnet force) or when the sensor 312 moves around the magnet. This current may therefore be utilized to determine if the collector's inner casing has extended, indicating a coupling to a charging dock 400.

The collector module 300 is shown in FIG. 3A(ii) as being in its default, non-charging state. This includes the inner casing 306 being recessed into the outer casing such that its magnets 302 and charging pads 304 are not exposed to the environment, as shown by these components 302, 304 being to the right of the line 317 which is the extent of the protective border 315. When in proximity to a magnetic source, the magnets 302 may pull the inner casing 306 outward such that the magnets 302 and charging pads 304 are to the left of line 317 and thereby able to make contact with charging pads of a power supply.

The hall effect sensor 312 may be disposed inside of the outer casing 308 and such that it remains in a static position regardless of the movement of the inner casing 306, wherein currents are induced in the hall effect sensor 312 when magnets 302 move relative to the hall effect sensor 312. Alternatively, hall effect sensor 312 may be disposed within the inner casing 306 in a movable position, wherein the hall effect sensor 312 senses nearby currents generated by its motion around a static magnet 302. When the inner casing 306 is proximate to an opposingly polarized magnetic source, magnets 302 will couple to the source and cause the inner casing 306 to extend towards that source. The extension opposes the spring force of springs 310, but also overcomes the force of springs 310 to facilitate the coupling. Movement of the inner casing 306 can be sensed by the hall effect sensor 312 when it either moves with respect to a static magnet 302, or detects a changing magnetic field due to a moving magnet 302, thereby providing an indication of when the collector 300 is coupled to something.

One skilled in the art may appreciate that use of magnets 302 to couple to opposing magnets of a charging station may pose a risk of accidentally magnetically coupling to metals or other magnetic sources which are not the charging dock. In these scenarios, the collector 300 should not receive or transmit power and have a means to decouple from the unintended magnetic source without damaging the collector 300.

Accordingly, in some embodiments, the inner casing 306 may further include mechanical elements to prevent the inner casing 306 from extending too far outward from the outer casing 308 and being detached from the outer casing 308. This may be beneficial in preventing the inner casing 306 from becoming dislodged from the outer casing 308 and/or causing plastic deformation in the springs 310. For example, stoppers 314 can limit the translational movement of the inner casing 306 and prevent further translational movement upon stoppers 314 of the inner casing 306 encountering another set of stoppers 314 of the outer casing 308. When inner casing 306 extends outward from outer casing 308, stoppers 314 provide a normal force which prevents the inner casing 306 from extending too much. For instance, if the magnets couple to another magnetic surface unintentionally, e.g., a metal pole, a metal shelf, etc., and the robot 102 attempts to move away, the mechanical stoppers withhold the inner casing 306 from extending past a certain point, which causes the magnets 302 to release from the other magnetic surface with which they unintentionally coupled as the normal force from the stoppers 314 and forces induced by the robot 102 motion overcome the magnetic force. In this way, stoppers 314 also prevent damage to the collector module 300 if the collector module 300 encounters a magnetic force that pulls the inner casing 306 too far outward and dislodging the inner casing 306 from the outer casing 308 and the collector module 300. Although shown in a two-dimensional cross-section, the stoppers 314 may comprise a singular border that encircles the inner casing 306 as shown in FIG. 3A(i).

The spring constant of springs 310 may depend on the strength of magnets 302. Springs which are too strong may require substantially strong magnets and increase costs. The springs, however, must be sufficiently strong to eventually overcome the magnetic force of magnets 302 upon the robot 102 leaving the charging station (e.g., backing away, opposite the magnetic attraction force on magnets 302) and enable the inner casing 306 to recess into the outer casing 308.

According to at least one non-limiting exemplary embodiment, electromagnets can be utilized in lieu of passive magnets 302 and activated only when the robot 102 is attempting to couple to a charging dock 400. While such electromagnets may be more expensive and require additional control and perception processes by the controller 118 to determine when to enable the electromagnets, which will be discussed below, they reduce the risk of the collector 300 accidentally coupling to magnetic surfaces that are not the charging dock 400. Further, use of passive magnets reduces complexity in decoupling from the dock as there are no active systems which may introduce failure points.

It is appreciated that to couple the charging pads 304 of the collector 300 to the pads of a docking station requires precise navigation and localization capabilities, wherein it cannot be safely assumed that every robot 102 is able to localize itself to precise locations (e.g., within 1-2 cm error). This problem is amplified after navigating long routes where odometry drift accumulates substantial localization errors (e.g., greater than 2 cm). Advantageously the collector 300 is configured to be tolerant of these imprecisions as discussed next in FIG. 3B(i-ii).

FIGS. 3B(i-ii) illustrate a collector 300 and its maneuverability to account for imperfect docking by the robot 102, according to an exemplary embodiment. As illustrated in FIG. 3B(i), the collector 300 may be coupled to a chassis 320 of a robot 102, wherein the chassis 320 is considered static in the reference frame of the robot 102. An additional set of springs 318 may be coupled to the outer shell 308 and the chassis 320 in order to couple the collector 300 to the chassis. Using springs 318 to couple collector 300 to chassis 320 enables additional maneuverability of collector 300, here via movement of outer casing 308, along an additional axis and dampens the force caused by the contact between the collector 300 and the charging dock when a robot 102 couples to the charging dock. Preferably, springs 318 have a spring constant larger than a spring constant of springs 310 because the maneuverability of the inner casing 306 is configured by springs 310, whereas springs 318 may provide some maneuverability but primarily provide the dampening effect upon the robot 102 coupling (effectively colliding with) the charging dock. In FIG. 3B(i) the inner casing 306 of the collector 300 is extended from its initial position 322 (dashed lines) because of magnets 302 coupling to another magnetic source. Ideally, with perfect navigation and localization, the robot 102 causes the charging pads 304 to contact the charging dock at normal incidence (i.e., 90° to the plane of the surface of the charging pads 304), thereby causing only horizontal extension of the inner casing 306 as shown in FIG. 3B(i). However, in practice, a non-tracked robot cannot perfectly localize itself nor navigate with infinite precision, and, accordingly, angular errors in the robotic approach to the charging dock must be anticipated.

As discussed above, the stoppers 314 prevent the inner casing 306 from extending beyond a maximum point which may be farther than the extensions seen during typical use. Accordingly, the stoppers 314 are not touching in the illustrated position.

FIG. 3B(ii) shows the collector 300 being extended upon the magnets 302 coupling to a magnetic source at non-normal incidence (magnetic source not illustrated). As shown, the inner casing 306 is extended outward with respect to its initial position 322, as shown by two axes 326 and 328. Axis 326 depicts the reference frame of the robot 102, which remains stationary in the drawing, while axis 328 represents the reference frame of the inner casing 306, which matches the axis 326 when in the non-extended state (e.g., see FIG. 3A(ii)). The inner casing 306 is also misaligned with the outer casing 308 because of the angular displacement, wherein the maximum tolerance of the angular displacement of the inner casing 306 is dependent on the relative size of the inner casing 306 with respect to the outer casing 308 (i.e., fit tolerance) and spring constant of springs 310. The outer casing 308 is also misaligned with the normal of the robot body 320, the normal shown in FIG. 3B(i) for reference, as a result of springs 318 providing an additional axis of rotation/translation 326 in addition to the axis of rotation/translation 328 for the inner casing 306 with respect to the outer casing 308. Springs 318 may be configured to provide less freedom of movement than springs 310 by having a greater spring constant while decreasing the mechanical shock and potential displacement caused by the magnets 302 coupling with an object like a charging dock.

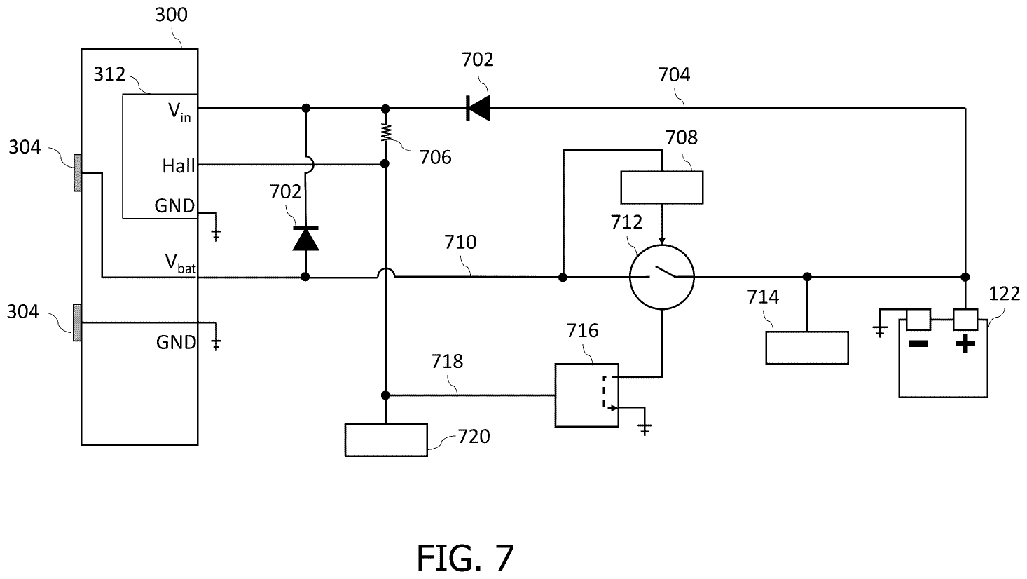

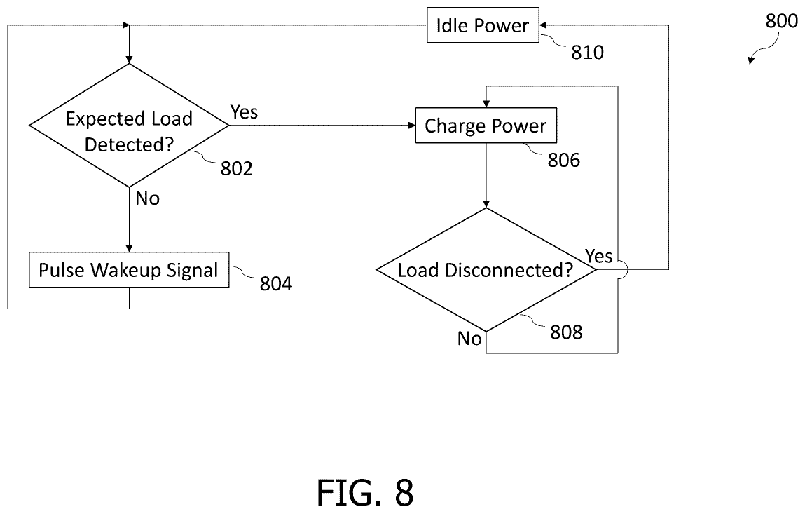

Advantageously, the collector module 300 shown and described in FIGS. 3A-B enables a robot 102 to approach a charging dock with less than perfect accuracy, without mechanical shock, and ensures proper connections with a charging port. As will be discussed in FIGS. 4-6 and 9 below, the charging dock itself is configured to enable a robot 102 to account for imperfect mating therewith. Additionally, systems that ensure charging/discharging only occurs when the charging pads 304 couple to a charging dock as a safety precaution, which further improve cost-savings via the use of passive magnets 302, will be discussed in FIGS. 7-8.

FIGS. 4(i-ii) illustrate two views of a charging dock 400 in accordance with some exemplary embodiments of the present disclosure. FIG. 4(i) illustrates a front-facing view of charging dock 400 corresponding to the ideal view a robot 102 should see if is approaching the dock at the perfect, normal angle. The charging dock 400 comprises three sections: a top section 402, a middle section 404, and a bottom section 408. The top section 402 may, in some embodiments, contain a homing code 418 that can be scanned by a robot 102 to provide information to robot 102, such as information about the charging dock 400 and its location in an environment (e.g., dock number #4 of 5 in the environment) and/or information about available routes and tasks that can be performed by a robot 102 starting from the charging dock 400. Code 418 may include a scannable image, such as a binary image like a quick-response (“QR”) code or barcode, which, upon being detected/imaged by one or more sensor units 114 of robot 102, causes the controller 118 to retrieve a library of stored information associated with the code 418, such as the available routes from the charging dock 400. In some embodiments, the top section may further include a user interface to enable a user to depower the charging dock 400 even if the robot 102 is coupled thereto. The user interface may further include various status indicators, such as light emitting diodes of various colors, to indicate an idle, charging, or off state for the charging dock 400.

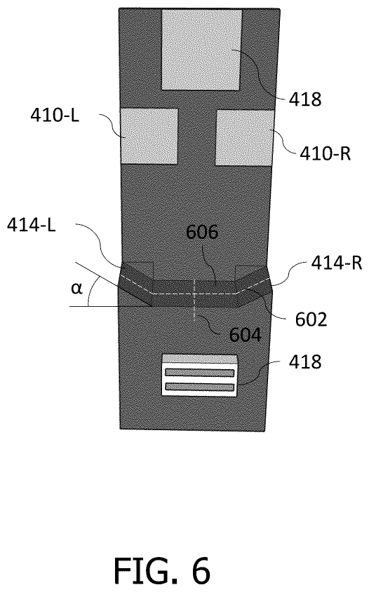

The middle section 404 of charging dock 400 may include a flat section 406, binary codes 410, and a point 412 to help localize the robot 102 and precisely guide it to the charging pads. First, two binary codes 410 are disposed on the left and right side of angled faces 414. The angled faces 414 extend vertically from a flat section 406. The flat section 406 comprises of a pentagon which is symmetrical along only one axis and comprises a point 412 on said axis of symmetry (shown via a dashed line). The pentagon shape of flat section 406 and its point 412 define the axis of symmetry which corresponds to the ideal heading angle of the robot 102 in approaching the dock 400. Such pentagonal surface 406 may be detected via LiDAR sensors (e.g., 2D, 3D or depth camera range sensors) to enable the controller 118 to determine (i) the ideal heading angle, and (ii) any deviation therefrom which can be adjusted for during approach or upon decoupling from the dock 400. This provides rapid feedback as to the true position of the robot 102, which is as accurate as the ranging sensors, that is more precise than a computer readable map the robot 102 otherwise utilizes to navigate its environment. Although shown using a pentagonal surface 406, any shape with an identical axis of symmetry would also suffice (as shown below in FIG. 6).

In addition to the pentagonal surface 406, the two angled codes 410-L and 410-R of middle section 404 also provide homing and approach angle information for the robot 102. For instance, the codes 410-L and 410-R may denote which dock, of potentially many docks in an environment, the illustrated dock 400 corresponds to and may contain similar information as code 418. In other situations, the dock 400 may be programmed as a known location in the environment such that, upon detecting the codes 410-L and/or 410-R, the robot 102 may localize itself in the environment, such as during start-up. The codes 410-L. 410-R may also provide relative position information in that, if a controller 118 only senses one code 410-R (e.g., as shown from the perspective in FIG. 4(ii)) the robot 102 may be able to determine if it is approaching the left or right side of the dock and localize the dock precisely. Additionally, the robot 102 may be able to localize the dock 400 during normal navigation as it moves past the dock 400, thereby adding an additional constraint to the mapping process since the dock 400 is at a known, static location (e.g., an origin point (0,0,0) if the robot 102 started navigation from the charging dock 400).

According to at least one non-limiting exemplary embodiment, the code(s) 410 may be affixed to the lower portion 408 and/or upper portion 402 of the dock 400. The exact placement of the code(s) 410 may further depend on the sensor configuration of the robot 102, namely the height of its cameras 502. In some embodiments, there may be one code 410 or there may be a plurality of codes 410.

The codes 410-L and 410-R may further contain a plurality of pixels of known size that provide depth and calibration information to the robot 102. For instance, the size of the pixels as seen by a sensor unit 114 of robot 102, e.g., a camera on the robot 102, may be compared to the known reference size of the pixels (i.e., the white squares/black on the code 410) to determine distance to the charging dock 400 and calibration of the camera of the robot 102. Once docked, the robot 102 may utilize the positions, sizes, and shapes of both angled codes 410-R and 410-L to calibrate its sensor units 114. For instance, sensor units 114 of the robot 102 may capture reference images of the codes 410-L an/or 410-R once docked at charging dock 400. Upon performing some tasks and returning to dock 400, the sensor units 114 may capture additional images of the codes 410-L. 410-R. If the pixels of codes 410-L, 410-R do not align with the known reference information, e.g., the pixels as detected by the sensor units 114 shifted to the right by “x” number of pixels, then controller 118 may determine the position of the robot 102 is misaligned by an amount corresponding to “x” number of pixels and/or the resolution of the pixels. Similarly, if the angles of the pixels do not align with the reference images, the sensor units 114 may be mis-calibrated and/or the robot 102 may be docked with the dock 400 at non-normal incidence.

In some embodiments, pentagonal surface 406 middle section 404 of charging dock 400 may be used to determine if camera sensor unit 114 of robot 102 is mis-calibrated, if the robot 102 is misaligned with the normal angle 426, shown in FIG. 4(ii), of the charging port 422 as robot 102 approaches charging dock 400 for charging, or both. For instance, if a camera of robot 102 detects the pentagonal surface 406 (particularly point 412 that defines the axis of symmetry for the pentagon) at a first location while a LIDAR sensor of robot 102 detects the same feature at a different location (while accounting for relative positions of both sensors) the difference may correspond to the mis-calibration of the camera sensor, the LiDAR sensor, or both. If both sensors agree on the location of the point 412 but there is still a deviation between the detected location and the location determined from the reference information, then it is likely that the robot 102 is approaching the charging dock 400 at an angle different from normal 426 of charging dock 400. In addition, distance measurements between the robot 102 and the slanted portions 414-L and 414-R may indicate angular deviation of the robot 102 as the angles of the slanted portions 414-L, 414-R are known in advance and saved in memory 120 for reference. Stated another way, the surface 406 provides a calibration reference at a known location using a known, fixed-sized reference target from which the robot 102 can determine its position. From this position, differences in the codes 410-L, 410-R captured at this position as compared to previous instances in time can be utilized for calibration of sensor units 114 as the pentagonal surface 406 provides reliable and accurate robot 102 location information.

Lastly, the charging dock 400 further comprises a lower portion 408 that in turn houses a charging port 422. Charging port 422 may include magnets 414 and charging pads 416. The magnets 414 are opposingly polarized to the magnets 302 of the collector module 300. Charging pads 416 may include two charging contacts: a ground and an active pad comprising a conductive material (e.g., copper, aluminum, alloys, etc.). The charging port 422 is positioned at a height above the floor such that the magnets 414 and charging pads 416 are at the same height, respectively, as the counterpart magnet 302 and charging pads 304 of the collector module 300 of the robot 102. Preferably, a surface area of respective contact faces of the magnets 414 and charging pads 416 (e.g., the faces visible in FIG. 4(i)) is greater than a surface area of the contact faces of respective magnets 302 and pads 304 (e.g., the faces visible in FIG. 3A(i)) of the collector 300. Enlarging the magnets 414 and pads 416 on the dock 400 may enable the system to still couple the robot 102 to the power supply even given an imperfect approach angle or position by the robot 102. However, in some embodiments, the pads may be smaller, provided the robot 102 navigation units and sensors are precise enough. Larger magnets 414 may come at a larger cost, larger pads 416 may experience resistive losses, and both may be more prone to damage, wherein one skilled in the art may configure the sizes of these components in accordance with their robot 102 specifications and costs.

The height (i.e., vertically along the page of FIG. 4(i)) of the magnets 414 and charging pads 416 may be approximately equal to a height of magnets 302 and charging pads 304 of the collector 300, respectively, to enabling coupling of magnets 414 and 304 and coupling of charging pads 304 and 416. If magnets 414 have a height that is too large, then magnets 302 and 414 may couple together while charging pads 304 and 416 do not, resulting in an uncoupled state of the charging pads while the magnets are touching the charging dock 400. The magnetic attractive force between magnets 302 and 414 configure them to be substantially aligned when coupled, thereby enabling alignment of the pads 414 to pads 304 and removing the need for large height charging pads 416. This magnetic alignment enables the charging pads 304 and 416 of both devices to be small while ensuring they are in contact when the magnets 302 and 414 are coupled.

It is appreciated that increasing the size of charging pads would, similarly, increase the range of heading angles and positions the robot 102 may execute while still facilitating coupling of the port 422 to the collector 300. Larger charging pads 416, however, may introduce resistive losses during power transfer and are at a higher risk of damage from external forces. Since the collector 300, specifically the inner casing 306, is movable translationally and rotationally, the magnets 302, 414 will thereby cause the pads 304, 416 to couple together at the proper locations, even if the robot 102 is not at the perfect normal approach angle.

The exact dimensions of the charging dock 400 are dependent on the size of the robot(s) 102 which uses it. Further, the arrangement of the sections referred to herein as the top section 402, middle section 404, and bottom section 408 may be rearranged in different ascending order from the floor. The particular arrangement may be based in part on the configuration of the robot 102 in question. For instance, according to at least one non-limiting exemplary embodiment, a robot 102 may be a tall robot operating in a shopping center, wherein the charging port 422 may be disposed on the top portion 402 above the floor rather than the bottom portion 408 near the floor to e.g., avoid collisions with shopping cart wheels or racks. Additionally, the middle section 404 should be placed at a height where the sensors of the robot 102 may detect the surface 406. Other robots 102, such as item transport robots 102, may include flat-beds or other payload carrying elements on their upper portions and therefore require the charging port 422 and their collector 300 to be closer to the floor than in the former example. The illustrated spatial arrangement of the elements is not intended to be limiting, however use of angled codes 410-R and 410-L and a surface 406 comprising a shape with at least one axis of symmetry corresponding to the normal approach angle that is/are detectable by at least a depth camera confers the benefit of enabling a robot 102 to precisely approach and couple to a charging dock 400 and account for errors therein. Lastly, relative terms such as top, middle, and bottom are not intended to be limiting on the overall inventiveness of the features present in each section 402, 404, 408.

According to at least one non-limiting exemplary embodiment, different robots 102 may require different charging docks 400 with different form factors. While storing an entire reference form factor in a memory 120 of the robot 102 may enable comparison by the controller 118 to detect compatible and incompatible charging docks 400, such methods may be memory intensive and slow operation of the robot 102. Advantageously, codes 418 and/or 410 may further encode information corresponding to which robot(s) 102 may dock with the corresponding charging dock 400 such that robot 102 is not required to permanently store this information in memory 120.

According to at least one non-limiting exemplary embodiment, a robot 102 may navigate in an exploration mode with the goal of mapping as much area as available. During navigation, beginning at a first charging dock 400, the robot 102 may pass by codes 410, 418 of one or more other charging docks 400 and localize them on a computer readable map. The codes 410, 418 provide the robot 102 with an indication that it is at a charging dock 400 that corresponds to the codes 410, 418 detected, as opposed to other objects which may have similar form factors or other docks 400 with different codes.

FIG. 4(ii) shows the same charging dock 400 from an angled, side view in accordance with some embodiments of this disclosure. As previously discussed, from this perspective, only one code 410-R is partially detectable which would immediately indicate the relative position of the robot 102 with respect to the dock 400. It is appreciated that the point 412 is not visible using any sensor modality from this perspective, though a depth camera or 3D LiDAR scan from this angle would yield a surface 406 with a pentagonal shape (highlighted in grey). The resulting pentagon, however, would not be symmetrical. Accordingly, the robot 102 can determine it is viewing a dock 400 but is unable to approach the dock 400 as the surface 406 is not symmetrical, thereby indicating the robot 102 must alter its approach angle. Alternatively, the detected portion of surface 406 illustrated may be compared to prior measurements of the surface 406 taken while the robot 102 is docked to indicate the current view angle is not the normal approach angle.

Enabling a robot 102 to accurately localize itself with respect to a static object at a known location may enable the robot 102 to account for accumulated drift during navigation and task execution. Drift, as used herein, corresponds to the accumulation of errors over time. For instance, a biased steering encoder may underestimate the amount turned by a robot by 1° to the left for every 45° of turn. Every left and right 45° section of turn then will be off by one degree, wherein the first turn will be off by 1°, the second turn will be off by 1° from its location which already includes a 1° error, and so forth. For short routes, this drift may not cause substantial issue, however over longer routes (e.g., hundreds of meters involving many turns) the drift may accumulate to a substantial level. The goal of the robot 102 in mating with the dock 400 is not to execute any task with any precision, rather it is a binary task involving “can dock” or “cannot dock,” wherein a robot 102 may not need to care about its position relative to other objects in the environment, which may be erroneously localized due to drift, in executing the task of mating with the dock 400. In other words, the robot 102 may effectively ‘forget’ its prior mapping of the environment, which could be prone to errors, and focus only on approaching the dock 400, which it can directly sense. Thus, the robot 102 can, upon recognizing a dock 400 is present, localize the dock 400 with respect to itself and account for any accumulated drift via localizing itself with respect to a known, fixed point. The fixed point in this case is the dock 400, and more specifically may be the location of the codes 410-R, 410-L, and/or surface 406. Stated another way, the robot 102 can, upon detecting the dock 400 relative to its current location, effectively reset or nullify any accumulated drift during its navigation, wherein accumulated mapping and position errors can be ignored in performing the task of coupling with the dock 400 since the robot 102 knows exactly where it is relative to the dock 400.

Following from the 1° leftward-biased steering encoder discussed above, the robot 102 may begin its task from the dock 400. The robot 102 is, at the beginning of the task, very well localized since drift has not been given ample time to accumulate. Over time, as the robot 102 navigates elsewhere, drift may accumulate to a notable level. For instance, a particle filter denoting the robot 102 position may increase in variance over time as the robot 102 moves. The controller 118 may not be able to determine whether the drift is substantial as the robot 102 navigates without additional mapping constraints to indicate drift is occurring. Many such methods are known within the art, such as feature-based mapping constraints (e.g., comparing locations of various objects to where they were seen in the past), and are considered herein without limitation. For instance, the robot 102 may pass by a bright yellow pole and, later, pass by the same pole, indicating the robot 102 is in approximately the same or similar location as before. However, use of such mapping methods in real-time may be costly for robots 102 with limited computing recourses, thereby limiting how well robots 102 are capable of accounting for drift. Further, feature poor environments (e.g., ones with a plurality of indistinguishable yellow poles) may cause such constraints to fail. Continuing the biased steering encoder example, the robot 102 may follow a route including thirty (30) left turns and forty-five right turns (45) and accumulate a large drift in its angular positioning over time. Upon completing the task, the robot 102 may attempt to return to the dock from its current location, wherein its current position may be based on an integration of its measured displacement over time from its initial starting position, including the drift. There is thus uncertainty in the true position of the robot 102 which may be resolved upon the robot 102 detecting one or both codes 410-L, 410-R of the dock 400.

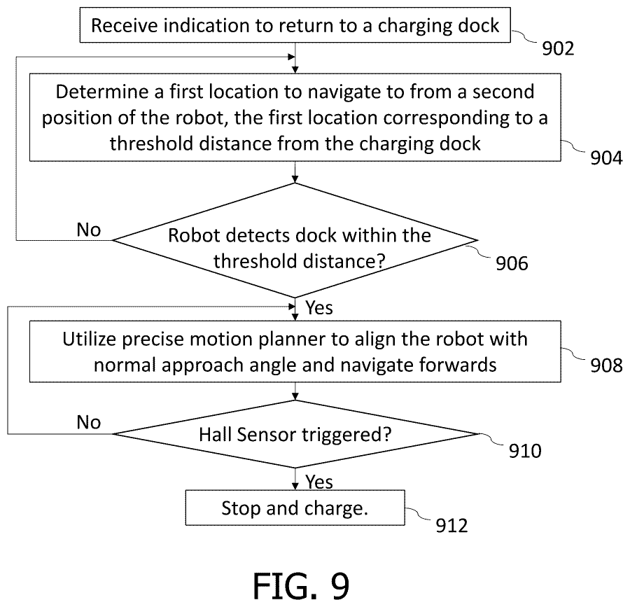

Upon detecting such codes, data from range sensors can provide an accurate position of the dock 400 with respect to the true position of the robot 102. That is, the robot 102 may localize the dock 400 independent of a map produced during execution of the route that is affected by the robot's drift (see, e.g., FIG. 9, blocks 904-908). For instance, the robot 102 may, on its map, determine it is right in front of the dock 400 with a perspective as shown in FIG. 4(i) when data from its sensor units 114 detect the dock with a perspective as shown in FIG. 4(ii). Data from the sensors can be utilized to determine whether the true position of the robot 102 is the perspective view shown in FIG. 4(ii) and, thus, the position of the robot 102 relative to the dock 400 can be accurately determined. Once localized using a static code at a known position, e.g., codes 410, 418, the drift in the map utilized by the robot can be removed or ignored during the approach to the dock 400. Once the static code is sensed by a robot 102, the distance between a robot 102 and the dock 400 itself is small enough wherein drift is no longer able to accumulate to substantial levels while the robot 102 approaches and couples to the dock 400. By utilizing the codes 410 to localize robot 102, any errors accumulated during navigation will not impact the robot 102's approach to the dock 400, thereby enabling the robot 102 to precisely move itself toward dock 400 to couple collector 300 to the charging port 422.

According to at least one non-limiting exemplary embodiment, the charging dock 400 may further contain a manual charging port 424 comprising of an extendable cable 420 which is housed within the dock 400. The cable 420 may be coiled or otherwise stored in a manner which is compact and retractable, such as by being coupled to a spring and a spool. Manual charging may be beneficial in the case of, e.g., damaged contact pads 306, 416; charging multiple robots 102 using the same dock 400; and/or at operator discretion (e.g., to quickly charge a dead robot 102 without manually aligning pads 306 to pads 416).

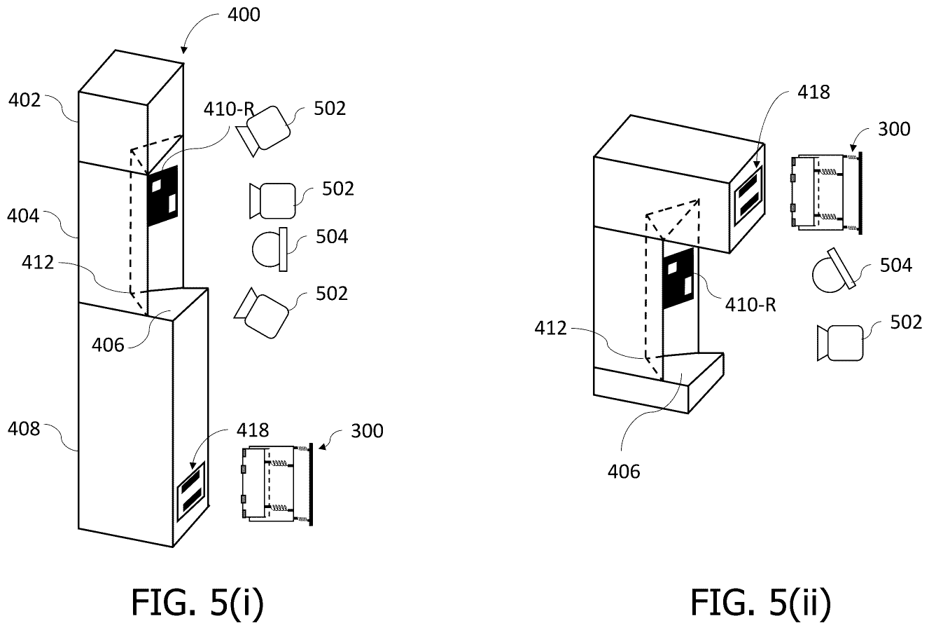

FIG. 5(i) illustrates the relative positions of various sensors that are compatible with the illustrated charging dock 400, according to an exemplary embodiment. The exact positions of the sensors are not intended to be limiting, but rather be illustrative of the benefits of the charging dock 400 disclosed herein. Two modalities of sensor units 114 are considered: cameras 502 and ranging sensors 504. Cameras include any sensors configured with a pixel array which produce data representing a visual scene. Ranging sensors 504 include sensors configured to return a range between the sensor and an object. In some instances, such as depth cameras, these sensors 502, 504 may be the same sensor. The cameras 502 are able to view the codes 410-R and 410-L (not shown due to perspective) when the collector 300 is mated with the port 422. Illustrated are three possible angles, 502A, 502B, and 502C, which include a head-on angle (middle) and top/bottom angled views. The three possible angles illustrated are not an exhaustive list nor are intended to be limiting. Any or all of the camera positions 502 may be used in accordance with the systems and methods discussed herein provided they can sense both codes 410-L and 410-R.

The range sensor 504 must be configured at a height and angle such that at least a portion of its field of view detects the pentagonal surface 406 and point 412 when mated with the dock 400. Preferably, the range sensor 504 detects both the surface 406 and point 412 while the robot 102 is a distance away from the dock to account for drift and heading angle as discussed above during approach. Similar constraints are shown in FIG. 5(ii) wherein a top portion 506 of the dock 400 now contains the charging port 422 and a lower portion 510 contains the angled surfaces 414 and codes 410, according to another exemplary embodiment. Lastly, the middle portion 508 in this embodiment also contains two slanted surfaces that form the pentagonal surface 406 and computer readable codes 410-L (obstructed) and 410-R affixed thereto. The same constraints in sensor positions are considered: one or more of cameras 502 must detect both codes 410-L, 410-R when collector 300 is mated with port 422; and range sensor 504 must detect the surface 406 and its single axis of symmetry 412 when collector module 300 is mated with port 422. Preferably, the cameras 502 can detect the codes 410-L. 410-R and range sensor 504 can detect the surface 406 and/or point 412 while the robot 102 is a distance away from the dock 400 and not coupled to the charging port 422. The exact form-factor of the robot 102 is intentionally not illustrated, as the benefits disclosed herein are not dependent on the form factor of the robot 102 beyond the positions of its sensor units 114.

According to at least one non-limiting exemplary embodiment, the codes 410-R, 410-L may be disposed on other surfaces of the charging dock 400, such as on the surface 406 of the pentagon, the top portion 402, bottom portion 408, and/or other portions of the dock 400 which are detectable by cameras of the robot 102. Slanted surfaces 414-R, 414-L still provide a heading angle for the robot 102 without codes 410-R, 410-L affixed thereto if they are detectable by range sensors 504, as is discussed with respect to FIG. 6.

According to at least one non-limiting exemplary embodiment, the slanted surfaces of the charging dock may be disposed elsewhere on the charging dock. For instance, FIG. 6 illustrates another non-limiting exemplary embodiment of a dock 600 comprising the inventive features discussed herein. The features discussed above are present in the illustrated dock 400, including the charging port 422, codes 410, and slanted surfaces 608-L and 608-R, however the features are rearranged as illustrated. The codes 410-L and 410-R are now disposed on a top portion 608 of the dock on a flat plane parallel to an axis of symmetry 602, which may also include a homing code 418. In alternative embodiments, the space for the third homing code 418 may be alternatively an interface that displays the status of the charging port as charging, idle, or off and may further include status indicators (e.g., lights) that display the amount of charge the robot 102 has received. The charging port 422 contains the same elements as discussed above, i.e., magnets 414 and charging pads 416. The slanted surfaces 608-L and 608-R connect via a flat surface 606. Surface 606 may have a rectangular shape with a width (measured along axis 604) equal to the widths of either slanted portion 608-L and 608-R and a length (measured along axis 602) of any known, arbitrary value. Unlike the previous embodiment illustrated in FIGS. 4(i-ii) and 5(i-ii), where the surface 406 has a pentagonal shape with one axis of symmetry, the illustrated embodiment includes two axes of symmetry, 602 and 604, that are perpendicular to each other with, but only one of the two corresponding to the ideal heading angle of the robot 102. A diagonal axis across the slanted surfaces 608-L and 608-R and surface 606 is not vertically symmetric and is thus not considered. Further, if aligned with axis 602, none of the codes 410-L, 410-R, or 418 would be detectable when viewed from the side (i.e., along axis 602) due to the codes being flat images.

To determine the ideal heading angle from the two axes of symmetry 602 and 604, a number of methods may be utilized. First, codes 410-L and 410-R, when both sensed, can provide an additional constraint on the ideal heading direction which would indicate axis 604 is the ideal heading direction, because if the robot 102 was angled along axis 602 both codes 410-L, 410-R would not be fully visible. Second, the surface normal of slanted surfaces 414-L and 414-R may be detected from LiDAR data and compared to a reference stored in memory which indicates, e.g., the surface normal vectors should point inwards (i.e., with an angular difference to 2a). A third method may involve detecting the flat surface 606, identifying the axis of symmetry 604, and aligning the robot 102 heading angle to that axis 604. Any, one or more, or other methods may be utilized without limitation based on the computational recourses available to the robot 102. Accordingly, although the illustrated embodiment includes a surface 606 with two axes of symmetry, provided one axis 604 corresponds to the ideal heading angle, the controller 118 of the robot 102 is able to determine which axis 602 or 604 is the correct ideal heading angle based on other symmetric properties of the dock 400 such as codes 410 and/or the slant of slanted surfaces 414. Advantageously this removes reliance on prior localization of the robot 102, which is subject to drift, to couple to the dock 400.

FIG. 7 is a circuit schematic configured to receive charge from a port 422 and provide the charge to a power supply 122 of a robot 102 using a dock 400 safely, according to an exemplary embodiment. The requirements for this circuit are: (i) the battery may be discharged (to anything aside from the system load 716) only when the collector 300 is coupled to something, and (ii) the “something” is only the charging port 422 and never other magnetic objects.

To achieve the first requirement, the hall sensor 312 output is utilized by a relay 716 that closes the circuit between a voltage regulator 708 and a ground, thereby creating a potential difference over a connector 712, causing it to close, and thereby cause a coupling of the pad 304 via line 710 to power supply 122 to provide power to a robot 102 (not shown). Without the hall sensor 312 signal, the switch 716 is an open circuit. The hall effect sensor 312 comprises three terminals: a input voltage terminal (Vin), a signal terminal (“Hall”), and a ground terminal (“GND”). The input voltage terminal receives power from the power supply 122 via a diode 702 that prevents flyback current from entering the power supply 122. Vin is also coupled to the power supply Vbat from the port 422 for reasons discussed below regarding a shorted charging pads case and dead battery 122 case. The value of Vbat corresponds to the voltage of the power supply 122 itself which also corresponds to the output voltage from the charging port 422. When the hall sensor 312 is not active, i.e., the inner casing 306 of collector 300 is not extended, the trace 718 is high (Vbat) due to pull up resistor 706. Upon being triggered, the hall sensor 312 opens a path to ground thereby causing trace 718 to be low (GND). Relay 716 may be an active low relay in this embodiment that closes the circuit upon receiving a low signal. Once the relay 716 is closed, a voltage is induced over the connector 712 thereby coupling line 710 to line 704. Accordingly, connector 712 is only closed and connects the power supply 122 to the charging pads 304 when the hall sensor 312 detects that the inner casing 306 has extended, indicating the collector 300 has coupled to something.

The next requirement is that the “something” the collector 300 is coupled to must be the charging port 422 and nothing else before charging/discharging the power supply 122. To achieve this requirement, some functions of the dock 400 must be defined.

FIG. 8 is a process flow diagram illustrating the various states and functions of the dock 400, according to an exemplary embodiment. The steps of the diagram 800 may be effectuated in part via a processor, micro-processor, or other computing unit executing computer readable instructions from a memory. The steps may also be effectuated in part via various hardware elements such as voltage regulators, function generators, ASICs, impedance matching circuits, and the like which operate without executing instructions from a memory.

Beginning with the dock 400 in an idle state, that is, with no robot 102 being charged, the dock 400 searches for an expected load in block 802. If a robot 102 is docked with the charging port 422, the dock 400 should expect to measure (i) an expected load impedance corresponding to the impedance between pads 304 of the collector 300, and (ii) an expected voltage corresponding to the power supply 122 of a robot 102, which could be fully charged or drained completely. By setting the expected voltage to be below a threshold power-off voltage of power supply 122 (e.g., 16 volts for a 22 volt power-off voltage), it can therefore be assumed that any voltage below than the threshold measured over charging pads 416 is not from a robot power supply 122 and therefore should not be receiving charge. This is because if a power supply 122 of a robot 102 dies while in operation, the voltage will not fall further as the robot 102 has been shut off, thereby enabling the dock 400 to couple to a “dead” battery. Stated another way, the expected load comprises at least a threshold voltage level (preferably lower than the minimum voltage needed to power the robot 102) and/or a range of impedance values.

Returning to the circuit diagram in FIG. 7, when the hall sensor 312 detects coupling of the inner casing, connector 712 closes thereby creating a path between output pads 416 and the power supply 122.

To initiate charging of the power supply 122, the dock 400 moves to block 804 to pulse a wake-up signal over the pads 416. If no robot 102 is presently charging, the wake-up signal goes no-were. If a robot 102 has just been moved into the dock 400 to charge, the dock 400 may not immediately detect the load until block 804 emits the wake-up signal which can be emitted at a pre-determined frequency (e.g., every 30 seconds). Once the wake-up signal is emitted, the process returns to block 802 to again search for an expected load over pads 416.

Returning to FIG. 7, the power supply 122 may, in some embodiments, comprise an internal battery management system (“BMS”). The BMS is a safety system integrated into a high-capacity power supply by original equipment manufacturers. For now, FIG. 7 will be described as though power supply 122 contains an integrated BMS. BMS may cause the power supply 122 to disconnect from a load if, e.g., excessive current draw is sensed (e.g., it may short). BMS may also cause the power supply 122 to not be active or not be configured to receive power until it receives a specific wake-up signal, such as one from a dock 400 executed at step 804 of FIG. 8. Accordingly, once the hall sensor 312 is triggered and connector 712 is closed, the trace 710 is connected to the power supply 122 and can provide the wake-up signal to the power supply 122 to begin charge/discharge.

In the case of a dead power supply 122, the power supplied by the input pad 304 enables the hall sensor 312 output to be driven low (due to pull-up resistor 706), closing the relay 716, and thereby closing connector 712 to enable the wake-up signal to be received by the power supply 122 to initiate charging.

In the case of either pads 416 or pads 304 being shorted (e.g., due to debris being present), the hall sensor output will be low and the relay 716 will close. However, the voltage measured at trace 710 will be zero, and accordingly no voltage will be applied over the connector 712, thereby leaving connector 712 open and protecting the power supply 122 and system load 714 from short-circuit discharge.

According to at least one non-limiting exemplary embodiment, if power supply 122 does not contain an integrated BMS, an alternative system can be utilized to meet the above requirements of the charging circuit. Trace 710 can be connected to a hardware element, such as a function generator configured to provide output upon detecting the pre-defined wake-up signal, configured to either close a connection between trace 710 and line 704 only upon the wake-up signal being received by YYY. For example, another voltage regulator may be coupled to trace 710 using another connector 712 such that the new connector 712 is only closed when the specific wake-up signal is received by the voltage regulator. However, it is appreciated that other common safety precautions offered by BMS will not be conferred (e.g., short-circuit protection between battery and system load 714).

Once the connector 712 is closed and the wake-up signal is received via trace 710 (which is now coupled to trace 704 to the power supply 122), the BMS may cause the power supply 122 to receive power from the pads 304. Returning to FIG. 8, the closing of connector 712 and receipt of the wake-up signal to engage the BMS in a charging mode causes the load over the charging pads 416 to match the expected load, wherein the process moves to block 806.

Block 806 includes the dock 400 providing charge power to its pads 416. Charge power corresponds to a specified wattage, or voltage and current values, provided to the power supply 122 of the robot 102 during charging. As a safety precaution, charge power should only be emitted when the collector 300 is paired with the port 422, e.g., to avoid shocking people or discharging in case of a short across pads 416. The process cycles between block 806 and block 808, which includes verifying the load is still coupled to the pads 416, until the robot 102 is disconnected from the dock 400. Once the robot 102 is disconnected, the cycle breaks and the process continues to block 810.

Block 810 includes the charging dock 400 returning to emitting idle power levels which, in some embodiments, may be zero watts (ignoring the periodic wake-up signal). Upon returning to emitting idle power, the dock 400 returns to block 802 to again search for another robot 102 being coupled to the dock 400.

According to at least one non-limiting exemplary embodiment, the charge power may be discontinued upon the power supply 122 reaching full capacity, which can be detected via pads 416 transmitting a current below a predetermined threshold current.

It is appreciated that the circuit schematic shown in FIG. 7 only illustrates the key operative elements needed to meet the above requirements of the system. The circuit may, in some embodiments, further contain various other elements such as, without limitation: impedance matching units, short circuit safety fuses, temperature control units for the power supply 122, and other circuit elements.

FIG. 9 is a process flow diagram illustrating a method 900 for a controller 118 of a robot 102 to charge its power supply 122 via a charging dock 400, according to an exemplary embodiment. Steps of method 900 may be effectuated via the controller 118 executing computer readable instructions from a non-transitory computer readable memory 120 stored thereon.

Method 900 begins at block 902 with the controller 118 receiving an indication to return to a charging dock 400. Such indication may be issued upon, for example and without limitation, the power supply 122 falling below a threshold level of power, upon completion of a task by a robot 102, or manually by an operator desiring to store away the robot 102 for later use/return the robot to a charging dock 400. The indication may be automatically generated by the controller 118, such as in the case of a low battery 122 and upon task completion. In some instances, a user my provide the indication via user interface units 112 (e.g., via selecting a “go home” option and, in some instances, selecting one dock 400 out of many) or via a device 208 coupled to the robot 102 through a server 202 (e.g., a cell phone via Bluetooth®). In some instances, the robot 102 may return to the dock 400 based on a schedule of tasks and/or a curfew (e.g., return to dock 400 after the store closes at 6:00 pm).

Next, block 904 includes the controller 118 determining a first position corresponding to the location of the dock 400 which the robot should navigate to. When controller 118 executes block 904, it is assumed that the robot 102 is currently at a second position somewhere in the environment away from the dock 400 and cannot immediately sense the dock 400. Both positions (i.e., the first position corresponding to the location of the dock 400 and the second position of the robot) are determined based on data stored in a computer readable map, which is susceptible to drift and errors as explained throughout this disclosure. Accordingly, the first and second positions are not precise, true physical positions of the robot 102 but rather estimated locations. It is appreciated that the controller 118 may not perfectly measure drift and errors over time and therefore the map cannot be considered ground truth. While the computer readable map is still reasonably accurate to navigate the robot near the dock 400, it cannot always be utilized to precisely mate the collector 300 to the port 422. The precision movement needed to mate the collector 300 to the port 422 is discussed in later steps of method 900. The computer readable map may be utilized to determine at least one path between the second position of the robot 102 and first position of the charging dock 400 since the robot 102 must have, at some earlier point, mapped such dock 400 (e.g., during the start of its route, in the past, or by passing by it) in order to have known about its existence and location. The dock 400 chosen could be one of a plurality of docks 400 available within the environment and mapped on the computer readable map. The controller 118 may determine other paths between the second and first locations, provided the area encompassed by such paths has been previously mapped to avoid potentially running into an unmapped dead end with low battery. If the path becomes blocked or the robot 102 is unable to progress further, method 900 may be paused and human assistance may be requested to clear the path.

According to at least one non-limiting exemplary embodiment, the robot 102 may be provided with a site map containing more mapped area than the single robot 102 has sensed and mapped. Specifically, site maps may contain most of the area in which the robot(s) 102 operate. For instance, the other mapped areas can be communicated from other robots 102 operating in those areas. In some instances, external sensors such as cameras, stationary LiDARs, radio frequency identification (RFID) devices, and the like can provide added map information. As such, a robot 102 with site maps may be able to determine a route between their current location and a dock 400 which the robot 102 has not used previously. That is, robots 102 are not constrained to only utilizing the dock(s) 400 which it has used previously, but rather must have a known and navigable path between the current position and the selected dock at the first location. Controller 118 may verify the path is navigable by simulating robot footprints along a path on the map, wherein the footprints represent the area occupied by the robot at various positions along the route to check for potential collisions with objects. In some embodiments, robot 102 may determining a closest charging dock 400 as the first location to navigate to based on the second location rather than determine the first location based on an identification of a specific charging dock 400 in the environment.

As the robot 102 navigates to the dock, the controller 118 may check that the robot 102 is within a threshold distance from the dock. Block 906 includes the controller determining if the robot 102 is within a predetermined threshold distance from the dock 400. In some embodiments, the controller 118 may verify that the estimated position of the robot 102 is within a threshold range from the dock 400 (typically, a selected dock 400 serves as the origin point of the map) using the computer readable map.

Alternatively, or additionally, the robot 102 may detect the presence of one or more codes 410-L. 410-R, and/or 418 to determine whether it is proximate to the dock 400. Proximate to, however, may not be within the threshold distance of block 906 yet. Using data from, e.g., range sensors such as LiDAR sensors and depth cameras, an accurate distance between the robot 102 and dock 400 may be determined. In some instances, data from imaging cameras may be utilized in conjunction with motion of robot 102 to determine distance to the codes 410, 418 (assuming the dock 400 is stationary). By detecting the dock ahead of time, the drift accumulated on the map can be substantially corrected and the dock 400 position relative to the robot 102 can be accurately determined. The robot 102 may then continue to navigate to the now identified dock 400 until it has reached the threshold distance.

By detecting the dock 400 itself, the robot 102 may utilize direct sensory observation of the dock 400 to localize itself with respect to the dock 400, thereby enabling a more precise localization for mating the collector 300 to the charging port 422 than relying on a computer readable map which is susceptible to accumulated errors and may be of lower resolution than the direct sensory data.

Upon the controller 118 determining the robot 102 is at the threshold distance from the dock 400, controller 118 moves to block 908.

Upon the controller 118 determining the robot 102 is farther than the threshold distance from the dock 400, controller 118 returns to block 904 to continue navigating closer.

According to at least one non-limiting exemplary embodiment, in rare instances, drift and calibration errors may be substantial to the point where a computer readable map is no longer usable, thereby causing a robot 102 to be unable to even begin navigating near where a dock 400 is estimated to be. In instances of highly erroneous maps, errors occur during task execution and human assistance may be hailed then. In these instances, assuming the controller 118 does not experience a collision, upon navigating to the threshold distance of where the erroneous map localizes the robot 102 and dock 400, the controller 118 may attempt to detect codes 410, 418. If no codes 410, 418 are sensed nearby, human assistance can be requested. In some embodiments, the robot 102 may perform a 360° spin to ensure there are no docks 400 (specifically, codes 410, 418) nearby. Requesting human assistance may involve the controller 118, for example, emitting a sound, emitting a visual cue (e.g., flashing lights), and/or transmitting a wireless signal to a device 208 (e.g., cell phone) of a human operator.

According to at least one non-limiting exemplary embodiment, the robot 102 may be commanded to return to a dock 400 by a user which is occupied by another robot 102 or blocked by an object. Failure to detect codes 410, 418 where they are expected to be based on the map may also be a result of the dock 400 being occupied by another robot 102 or blocked by an object. Accordingly, if no dock 400 is sensed where the map estimates it to be or if the dock is blocked/occupied, the controller 118 may hail for human assistance.

According to at least one non-limiting exemplary embodiment, a dock 400 being occupied by a robot 102 may be communicated to a server 202. In turn, human operators of robots 102 within the network 210 may be prevented from commanding (via devices 208) a robot 102 to navigate to an occupied dock 400 and may be prompted to select another dock 400.

Block 908 includes the controller 118 utilizing a precise motion planner to align the robot with the proper approach angle and begin navigating forwards into the dock 400. The proper approach angle corresponds to the robot 102 approaching (approximately) the dock 400 along an axis of the surface normal vector of the surface of the charging pads 416 of the dock 400 (i.e., out of/into the page in FIG. 4(i)). Various motion planning algorithms are utilized within the art, each with their advantages and drawbacks. Typically, there is a trade-off between (i) precision, and (ii) computation performance. That is, more precise motion planners often require more processing, time, and memory than less precise ones but have the added benefit of improved motion precision. For general navigation, especially for long routes (e.g., 100 meters or longer), less precise motion planners are preferred so long as the robot 102 can still complete its task to a reasonable degree to save on cost of the robot 102. However, such motion planners may not be precise enough to enable a robot 102 to approach a dock 400 to mate pads 306, 416 accurately. Accordingly, for the short distance and time needed for the robot 102 to approach the dock, more precise algorithms are utilized and the controller 118 may switch its motion planning algorithm. Recall that since the robot 102 can see codes 410 and/or 418, the robot 102 is accurately localized with respect to the dock 400 which may eliminate errors accumulated while using the prior, less-precise motion planner.

Continuous location feedback is provided via the shape and features of the charging dock 400 as the robot 102 approaches. Namely, orientation (i.e., angle of approach) information may be measured via point 412 and/or detecting axes of symmetries of the surface 406 as well as slanted surfaces 414. Location, namely distance to the dock 400, can be determined based on the size of the codes 410, 418 and/or their elements (e.g., black/white pixels) relative to a reference. The reference may comprise, for example, an image taken of the codes 410, 418 while the robot 102 is docked. Distance information may also be obtained from range sensors, however range sensors (e.g., infrared LiDAR) may become excessively noisy when measuring short distances.

The robot 102 will continue navigating forwards until, in block 910, the controller 118 detects the hall sensor 312 is triggered. The output of the hall sensor 312 is provided to a solid-state relay 716, as shown in FIG. 7 above, to enable a connector to close a connection between the pad 304 and power supply 122. The hall sensor output may also be provided to a vehicle interface control input 720, shown in FIG. 7, which receives low-level firmware data (e.g., the hall sensor 312 output) for the controller 118 to consider in motion planning. The hall sensor 312 being triggered may thereby cause the controller 118 to cease movement of the robot 102.

Upon the controller 118 detecting the hall sensor 312 is triggered, the controller 118 moves to block 912 where it stops moving and begins charging.

If the controller 118 does not detect the hall sensor 312 is triggered, the controller 118 returns to block 908 and continues to navigate forwards.

In block 912 the controller 118 stops the robot 102 and charges its power supply 122. In some embodiments, the controller 118 may shut down various operative units and enter a low-power, idle, or off state while charging.

Advantageously, method 900 enables a robot 102 to account for accumulated drift prior to performing a precise maneuver to couple its collector 300 to port 422. By accounting for accumulated drift, the performance of the robot 102 precisely coupling the collector 300 to port 416 can be readily achieved. Further, by switching to a more precise, yet computationally more expensive (e.g., memory, cycle time, CPU/GPU usage, etc.) the robot 102 can even more readily couple to the port 422, wherein the additional computational complexity is acceptable due to the lack of other tasks or potential risks (e.g., nearby moving objects) involved in docking across a short distance. Lastly, by using the features of the charging dock 400, continuous and highly precise location feedback can be provided to the navigation system while the robot 102 approaches the port 422 in block 908.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation.” “including but not limited to,” or the like; the term “comprising” as used herein is synonymous with “including.” “containing,” or “characterized by.” and is inclusive or open-ended and does not exclude additional, unrecited elements or method steps; the term “having” should be interpreted as “having at least;” the term “such as” should be interpreted as “such as, without limitation:” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A charging system for a robot, comprising:
a charging dock system comprising:
a first surface comprising an axis of symmetry which is aligned with an approach angle normal to a charging port, the charging port comprising two or more charging pads;
one or more slanted surfaces; and
one or more positioning codes affixed to the charging dock in a position transverse to the approach angle;
a robot navigation system configured to:
detect the one or more positioning codes;
determine a location of the charging dock based on the detected positioning codes; and
determine a position of the robot relative to the detected positioning codes to align the robot with the charging dock; and
a collector module system comprising:
a pair of charging pads disposed on an external face of an inner casing at a distance equal to a spatial separation between the two or more charging pads of the charging dock;
one or more magnets disposed within the inner casing adjacent to the pair of charging pads;
one or more springs coupled to a surface of the inner casing; and
a circuit configured to couple a power supply of the robot to the charging dock via the pair of charging pads of the collector module system and the two or more charging pads of the charging dock.

2. The charging system of claim 1, wherein the one or more positioning codes comprise instructions that, when detected by a sensor of the robot, cause the robot navigation system to determine the location of the charging dock and the position of the robot.

3. The charging system of claim 1, wherein the collector module system further comprises:
an outer casing; and
the inner casing disposed within the outer casing.

4. The charging system of claim 3, wherein the collector module system further comprises:
a hall effect sensor disposed within the inner casing, the hall effect sensor configured to detect alignment between the collector module system and the charging dock system.

5. The charging system of claim 1, wherein the first surface of the charging dock system comprises at least one axis of symmetry.

6. The charging system of claim 1, wherein the two or more charging pads of the charging dock system are disposed on a first outer surface of the charging dock.

7. The charging system of claim 6, wherein the one or more slanted surfaces are slanted with respect to the first outer surface.

8. A method for charging a robot, comprising:
providing a charging dock system comprising a first surface, the first surface comprising an axis of symmetry which is aligned with an approach angle normal to a charging port, the charging port comprising two or more charging pads, one or more slanted surfaces, and one or more positioning codes affixed to the charging dock in a position transverse to the approach angle;
detecting, by a robot navigation system, the one or more positioning codes;
determining, by the robot navigation system, a location of the charging dock based on the detected positioning codes;
determining, by the robot navigation system, a position of the robot relative to the detected positioning codes to align the robot with the charging dock;
aligning a collector module system of the robot with the charging dock system, the collector module system comprising a pair of charging pads disposed on an external face of an inner casing at a distance equal to a spatial separation between the two or more charging pads of the charging dock, one or more magnets disposed within the inner casing adjacent to the pair of charging pads, and one or more springs coupled to a surface of the inner casing; and
coupling, via a circuit, a power supply of the robot to the charging dock via the pair of charging pads of the collector module system and the two or more charging pads of the charging dock.

9. The method of claim 8, wherein the one or more positioning codes comprise instructions that, when detected by a sensor of the robot, cause the robot navigation system to determine the location of the charging dock and the position of the robot.

10. The method of claim 8, wherein aligning the collector module system of the robot with the charging dock system further comprises:
detecting, by a hall effect sensor disposed within the inner casing of the collector module system, alignment between the collector module system and the charging dock system.

11. The method of claim 8, wherein the first surface of the charging dock system comprises at least one axis of symmetry.

12. The method of claim 8, wherein the two or more charging pads of the charging dock system are disposed on a first outer surface of the charging dock.

13. The method of claim 12, wherein the one or more slanted surfaces are slanted with respect to the first outer surface.

14. A robot, comprising:
a navigation system configured to:
detect one or more positioning codes affixed to a charging dock;
determine a location of the charging dock based on the detected positioning codes; and
determine a position of the robot relative to the detected positioning codes to align the robot with the charging dock; and
a collector module system comprising:
a pair of charging pads disposed on an external face of an inner casing at a distance equal to a spatial separation between two or more charging pads of the charging dock;
one or more magnets disposed within the inner casing adjacent to the pair of charging pads;
one or more springs coupled to a surface of the inner casing; and
a circuit configured to couple a power supply of the robot to the charging dock via the pair of charging pads of the collector module system and the two or more charging pads of the charging dock.

15. The robot of claim 14, wherein the one or more positioning codes comprise instructions that, when detected by a sensor of the robot, cause the navigation system to determine the location of the charging dock and the position of the robot.

16. The robot of claim 14, wherein the collector module system further comprises:
an outer casing; and
the inner casing disposed within the outer casing.

17. The robot of claim 16, wherein the collector module system further comprises:
a hall effect sensor disposed within the inner casing, the hall effect sensor configured to detect alignment between the collector module system and the charging dock.

18. The robot of claim 14, wherein the charging dock comprises a first surface aligned with an approach angle normal to a charging port, the charging port comprising the two or more charging pads.

19. The robot of claim 18, wherein the charging dock further comprises one or more slanted surfaces to guide the robot, the one or more slanted surfaces being slanted with respect to a first outer surface of the charging dock on which the two or more charging pads are disposed.

20. The robot of claim 18, wherein the first surface of the charging dock comprises at least one axis of symmetry which is aligned with a surface normal of the pair of charging pads.
